(19) United States
(12) Patent Application Publication
(10) Pub. No.: US 2009/0093443 A1
(43) Pub. Date: Apr. 9, 2009

(54) COMBINATIONS OF 4- BROMO-2-(4-CHLOROPHENYL)-5-(TRIFLUOROMETHYL)-1H-PYRROLE-3-CARBONITRILE AND BIOCIDAL COMPOUNDS

(75) Inventors: Tony Mathilde Jozef Kempen, Kapellen (BE); Ludo Antoinnette De Witte, Merksplas (BE); Jan Pieter Hendrik Bosselaers, Beerse (BE)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: JASSEN PHARMACEUTICA N.V., Beerse (BE)

(21) Appl. No.: 12/296,353

(22) PCT Filed: Apr. 10, 2007
(86) PCT No.: PCT/EP07/53449

§ 371 Date: Oct. 7, 2008

(30) Foreign Application Priority Data
Apr. 10, 2006 (EP) 06112435.0

(51) Int. Cl. A01N 55/08; A01N 43/36; A01N 43/64

(52) U.S. Cl. 514/64; 514/427; 514/245

(57) ABSTRACT

The present invention relates to combinations of 4-bromo-2-(4-chloro-phenyl)-5-(trifluoromethyl)-1H-pyrrole-3-carbonitrile, or a salt thereof, and a biocidal compound which provide an improved protecting effect against fouling organisms. More particularly, the present invention relates to compositions comprising a combination of 4-bromo-2-(4-chlorophenyl)-5-(trifluoromethyl)-1H-pyrrole-3-carbonitrile, or a salt thereof, together with one or more biocidal compounds selected from (4-isopropyl-pyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol or a derivative thereof, N,N-bis(3-aminopropyl)dodecylamine, coco(fractionated)benzyldimethylammonium chloride, peracetic acid, pyridaben, tebufenpyrad, and zosteric acid; in respective proportions to provide a synergistic effect against fouling organisms and the use of these compositions for protecting materials against fouling organisms.

### CROSS REFERENCE TO RELATED APPLICATIONS

This application is the national stage of Application No. PCT/EP2007/053449, filed Apr. 10, 2007 (hereby incorporated by reference herein), which application claims priority from EPO Patent Application No. 06112435.0, filed Apr. 10, 2006.

The present invention relates to combinations of 4-bromo-2-(4-chloro-phenyl)-5-(trifluoromethyl)-1H-pyrrole-3-carbonitrile, or a salt thereof, and a biocidal compound which provide an improved protecting effect against fouling organisms. More particularly, the present invention relates to compositions comprising a combination of 4-bromo-2-(4-chlorophenyl)-5-(trifluoromethyl)-1H-pyrrole-3-carbonitrile, or a salt thereof, together with one or more biocidal compounds selected from (4-isopropylpyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol or a derivative thereof, N, N-bis(3-aminopropyl)dodecylamine, coco(fractionated)benzyldimethylammonium chloride, peracetic acid, pyridaben, tebufenpyrad, and zosteric acid; in respective proportions to provide a synergistic effect against fouling organisms and the use of these compositions for protecting materials against fouling organisms.

It has now been found that the combination of 4-bromo-2-(4-chloro-phenyl)-5-(trifluoromethyl)-1H-pyrrole-3-carbonitrile (hereinafter referred to as component 1) and a biocidal compound selected from 4-bromo-2-(4-chlorophenyl)-5-(trifluoromethyl)-1H-pyrrole-3-carbonitrile, or a salt thereof, together with one or more biocidal compounds selected from (4-isopropylpyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol or a derivative thereof, N,N-bis(3-aminopropyl)dodecylamine, coco(fractionated)benzyldimethylammonium chloride (CAS 68424-85-1, commercially known as ARQUAD MCB-50 from Akzo Nobel), peracetic acid, pyridaben, tebufenpyrad, and zosteric acid (hereinafter referred to as a component 11), has a synergistic effect on the control of fouling organisms. As used herein, “control” is defined to include the inhibition of attachment or settlement of fouling organisms to the surface of an object, the removal of fouling organisms that are attached to the surface of an object, and the growth of fouling organisms.

4-Bromo-2-(4-chlorophenyl )-5-(trifluoromethyl)-1H-pyrrole-3-carbonitrile is disclosed in EP-0,312,723 for controlling molluscs. Said compound can be represented by the formula:

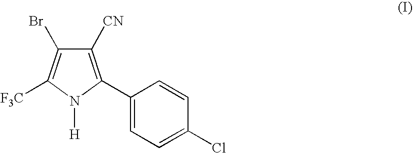

EP-0,746,979 describes the use of 4-bromo-2-(4-chlorophenyl)-5-(trifluoromethyl)-1H-pyrrole-3-carbonitrile in antifoulant compositions which are applied to underwater surfaces in order to prevent the attachment of fouling organisms to said underwater surfaces. WO-03/039256 discloses combinations of 4-bromo-2-(4-chlorophenyl)-5-(trifluoromethyl)-1H-pyrrole-3-carbonitrile with bethoxazin, DCO IT, tolylfluanid and dichlofluanid for protecting materials against fouling organisms.

The biocidal compounds referred to as components (II), are the following:
component (II-a): (4-isopropylpyridinio)methyldiphenylboron;
component (II-b): triphenylboron pyridine;
component (II-c): benzalkonium chloride;
component (II-d): capsaicine;
component (II-e): clonidine;
component (II-f): fenazaquin;
component (II-g): glutaric dialdehyde;
component (II-h): menadione sodium bisulfite;
component (II-i): menadione piperazine bisulfite;
component (II-j): menadione triaminetriazine bisulfite;
component (II-k): menthol or a derivative thereof;
component (II-l): N,N-bis(3-aminopropyl)dodecylamine;
component (II-m): coco(fractionated)benzyldimethylammonium chloride (CAS 68424-85-1, commercially known as ARQUAD MCB-50 from Akzo Nobel);
component (II-n): peracetic acid;
component (II-o): pyridaben;
component (II-p): tebufenpyrad; and
component (II-r): zosteric acid.

Derivatives of menthol are e.g. (−)-menthol, (−)-trans-p-menthan-3,8-diol, (−)-menthyl chloride, 3-[[5-methyl-2-(l methylethyl)cyclohexylloxyl-1,2-propanediol (also known as menthol propylene glycol carbonate), (−)-isopulegol), and (−)-menthone, which have been described as antifouling agents in WO-01/95718. Another derivative is menthol propyleneglycol carbonate which has been described for its insect repellent activity in WO-2005/025313.

Wherever the term “4-bromo-2-(4-chlorophenyl)-5-(trifluoromethyl)-1H-pyrrole-3-carbonitrile” or component (I) is used throughout this text, it is meant to include said compound both in base or in salt form, the latter being obtained by reaction of the base form with an appropriate acid. Appropriate acids comprise, for example, inorganic acids, such as the hydrohalic acids, i.e. hydrofluoric, hydrochloric, hydrobromic and hydroiodic, sulfuric acid, nitric acid, phosphoric acid, phosphinic acid and the like; or organic acids, such as, for example, acetic, propanoic, hydroxyacetic, 2-hydroxypropanoic, 2-oxopropanoic, ethanedioic, propanedioic, butanedioic, (Z)-2-butenedioic, (E)-2-butenedioic, 2-hydroxybutanedioic, 2,3-dihydroxybutanedioic, 2-hydroxy-1,2,3-propanetricarboxylic, methanesulfonic, ethanesulfonic, benzenesulfonic, 4-methyl-benzenesulfonic, cyclohexanesulfamic, 2-hydroxybenzoic, 4-amino-2-hydroxybenzoic and the like acids. Said component (I) may also exist in the form of solvates, such as hydrates.

Surfaces or objects exposed to humid or aqueous environments are readily colonized by aquatic organisms such as algae, fungi, bacteria, microbes, and aquatic animals such as, e.g. tunicates, hydroids, bivalves, bryozoans, polychaete worms, sponges, barnacles, and molluscs. As these organisms settle on or attach to said surfaces, the value of the exposed objects diminishes. The attachment or settlement of said organisms is also known as ‘fouling’ of a structure. The exterior, but possibly also the interior of the object may deteriorate, the surface changes, e.g. from smooth, clean and streamlined to rough, foul and turbulent, the weight of the object increases by the deposit of the organisms and their remnants, and the vicinity of the object may become obstructed or encumbered. The function of the object and system involved lowers and the quality of the aqueous environment deteriorates. The common method of controlling the attachment of fouling organisms is by coating the structure to be protected with a composition which comprises an antifouling agent.

The combinations as claimed in the present invention are especially suitable to protect surfaces or objects in constant or frequent contact with water from fouling or attachment or settlement of algae, by applying to said surfaces or objects a composition comprising component (I) and one of the components (II) in respective proportions to provide a synergistic effect against fouling organisms.

Examples of said surfaces or objects are for instance, shiphulls, harbor installations, piers and pilings, drying docks, sluice-gates, locks, mooring masts, buoys, offshore oil rigging equipment, drilling platforms, bridges, pipelines, fishing nets, cables, ballast water tanks, ship reservoirs that draw water from infested bodies of water, recreational equipment, such as surfboards, jet skis, and water skis, and any other object in constant or frequent contact with water.

The invention also provides a method to protect materials, in particular surfaces or objects in frequent or constant contact with water, against fouling organisms by applying to said objects a composition comprising an effective antifouling amount of a combination of component (I) together with one of the components (II) wherein the amount of component (I) and component (II) are in respective proportions to provide a synergistic effect against fouling organisms. An “antifouling effective amount” is that amount that will kill or inhibit the growth, reproduction or spread of a significant number of fouling organisms.

The present invention further provides a method of protecting a surface which comprises applying to the surface a composition comprising an effective antifouling amount of a combination of component (I) together with one of the components (II) wherein the amount of component (I) and component (II) are in respective proportions to provide a synergistic effect against fouling organisms. An especially important use of the method of the invention comprises a method for inhibiting fouling of a ship's hull, which comprises applying to the hull an antifouling composition in accordance with the invention. Fouling on the hulls of ships for example increases frictional drag with a corresponding decrease in speed and maneuverability and an increase in fuel consumption and increased maintenance costs associated with removal of the fouling.

The compositions comprising a combination of component (I) together with one of the components (II) wherein the amount of component (I) and component (II) are in respective proportions to provide a synergistic effect against fouling organisms can be used to protect constructions such as, e.g. swimming pools, baths, cooling water circulation circuits and industrial baths in various installations, e.g. in manufacturing plants or in air-conditioning installations, the function of which can be impaired by the presence and/or the multiplication of fouling organisms. Further examples are buildings and parts of buildings such as floors, outer and inner walls or ceilings, or places suffering from dampness such as cellars, bathrooms, kitchens, washing houses and the like, and which are hot-beds for fouling. Fouling not only is problematic from the viewpoint of hygiene and aesthetics, but also causes economic losses because said buildings and/or decorating materials deteriorate more rapidly than desired.

Another application of the combinations of the present invention is the treatment or disinfection of ballast water to reduce or eliminate the presence of aquatic organisms such as phytoplankton (dinoflagellates and diatoms), crustaceans (crabs, shrimp, copepods, amphipods), rotifers, polychaetes, mollusks, fish, echinoderms, ctenophores, and coelenterates.

The synergistic antifouling compositions of the present invention can also be used in a variety of applications:
industrial aqueous process fluids, e.g. cooling waters, pulp and paper mill process waters and suspensions, secondary oil recovery systems, spinning fluids, metal working fluids, and the like
in-tank/in-can protection of aqueous functional fluids, e.g. polymer emulsions, water based paints and adhesives, glues, starch slurries, thickener solutions, gelatin, wax emulsions, inks, polishes, pigment and mineral slurries, rubber latexes, concrete additives, drilling mud's, toiletries, aqueous cosmetic formulations, pharmaceutical formulations, and the like.

The term “fouling organisms” is meant to comprise organisms that attach, settle, grow on or adhere to various kinds of surfaces, in particular in humid or aqueous environments such as, marine waters, fresh waters, brackish waters, rain water, and also cooling water, drainage water, waste water and sewage. Fouling organisms are Algae such as, for example, Microalgae, e.g. Amphora, Achnanthes, Navicula, Amphiprora, Melosira, Cocconeis, Chlamydomonas, Chlorella, Ulothrix, Anabaena, Phaeodactylum, Porphyridium; Macroalgae, e.g. Enteromorpha, Cladophora, Ectocarpus, Acrochaetium, Ceramium, Polysiphonia and Hormidium sp.; fungi; microbes; tunicates, including members of the class Ascidiacea such as Ciona intestinalis, Diplosoma listerianium, and Botryllus schlosseri; members of the class Hydrozoa, including Clava squamata, Hydractinia echinata, Obelia geniculata and Tubularia larynx; bivalves, including Mytilus edulis, Crassostrea virginica, Ostrea edulis, Ostrea chilensia, Dreissena polymorpha (zebra mussels) and Lasaea rubra; bryozoans, including Electra pilosa, Bugula neritina, and Bowerbankia gracilis; polychaete worms, including Hydroides norvegica; sponges; and members of the class Crustacea, including Artemia, and Cirripedia (barnacles), such as Balanus amphitrite, Lepas anatifera, Balanus balanus, Balanus balanoides, Balanus hameri, Balanus crenatus, Balanus improvisus, Balanus galeatus, and Balanus eburneus; and Elminius modestus, and Verruca.

The relative proportions of component (I) and one of the components (II) in compositions comprising a combination of component (I) and one of the components (II) are those proportions which result in a synergistic effect against fouling organisms when compared to a composition including, as an active ingredient, either component (I) alone or a component (II) alone. As will be understood by those skilled in the art, the said synergistic effect may be obtained within various proportions of components (I) and (II) in the composition, depending on the kind of fouling organism towards which effect is measured and the substrate to be treated. Based on the teachings of the present application, determination of the synergistic effect of such combinations can be performed according to the procedures of the Poison Plate Assay as described in Experiment 1. As a general rule, however, it may be said that for most fouling organisms the suitable proportions by weight of the amount of component (I) to component (II) in the combinations should lie in the range from 10:1 to 1:10. Particularly, this range is from 8:2 to 2:8, more particularly from 3:1 to 1:3 or 2:1 to 1:2. Another particular ratio of component (I) to component (II) in the compositions of the present invention is a 1:1 ratio between component (I) and one of the components (II).

The quantity of each of the active ingredients in compositions comprising a combination of component (I) and one of the components (II) will be so that a synergistic effect is obtained. In particular it is contemplated that the ready to use compositions of the present invention comprise component (I) in an amount of at least 1 wt % based on the total weight of the composition. In particular such ready to use compositions comprise component (I) in an amount from 1 wt % to 40 wt %, or more particular from 3 wt % to 30 wt %, based on the total weight of the composition. The amount of component (II) in said ready to use compositions will be so that a synergistic antifouling effect is obtained. In particular the amount of component (II) may range from 1 wt % to 30 wt %, more particular from 2 wt % to 20 wt % based on the total weight of the dry mass of the composition. In many instances the antifouling compositions to be used directly can be obtained from concentrates, such as e.g. emulsifiable concentrates, suspension concentrates, or soluble concentrates, upon dilution with aqueous or organic media, such concentrates being intended to be covered by the term composition as used in the definitions of the present invention. Concentrates used in the form of a paint composition can be diluted to a ready to use mixture in a spray tank shortly before use.

A composition comprising a combination of component (I) and one of the components (II) in respective proportions to provide a synergistic effect against fouling organisms is thus suitably used together with carriers and additives, including wetting agents, dispersing agents, stickers, adhesives, emulsifying agents and the like such as those conventionally employed by the artisan in preparing antifouling compositions. The antifouling compositions of the present invention may further comprise suitable substances known in the art of formulation, such as, for example natural or regenerated mineral substances, solvents, dispersants, surfactants, wetting agents, adhesives, thickeners, binders, anti-freeze agents, repellents, colour additives, corrosion inhibitors, water-repelling agents, siccatives, UV-stabilizers and other active ingredients. Suitable surfactants are non-ionic, cationic and/or anionic surfactants having good emulsifying, dispersing and wetting properties. The term “surfactants” will also be understood as comprising mixtures of surfactants.

Antifouling compositions comprising a combination of component (I) and one of the components (II) in respective proportions to provide a synergistic effect against fouling organisms may be prepared in any known manner, for instance by homogeneously mixing, coating and/or grinding the combination of active ingredients (i.e. component (I) and one of the components (II)), in a one-step or multi-steps procedure, with the selected carrier material and, where appropriate, the other additives such as surface-active agents, dispersants, thickeners, binders, colour additives, corrosion inhibitors and the like.

Suitable carriers for solid formulations, such as dusts, dispersable or flowable powders, are any dispersant that does not adversely affect the active ingredients, for example, clays (for example, kaolin, bentonite, acid clay, and the like), talcs (for example, talc powder, agalmatolite powder, and the like), silicas (for example, diatomaceous earth, silicic acid anhydride, mica powder, and the like), alumina, sulfur powder, activated charcoal, and the like. These solid carriers may be used either singly or in combination of two or more species

Appropriate carriers for liquid formulations are any liquid that does not adversely affect the active ingredients, for example, water, alcohols (for example, methyl alcohol, ethyl alcohol, ethylene glycol, propylene glycol, diethylene glycol, glycerin, etc.), ketones (for example, acetone, methyl ethyl ketone, etc.), ethers (for example, dioxane, tetrahydrofuran, cellosolve, diethylene glycol dimethyl ether, etc.), aliphatic hydrocarbons (for example, hexane, kerosene, etc.), aromatic hydrocarbons (for example, benzene, toluene, xylene, solvent naphtha, methyl naphthalene, etc.), halogenated hydrocarbons (for example, chloroform, carbon tetrachloride, etc.), acid amides (for example, dimethyl formadide, etc.), esters (for example, methyl acetate ester, ethyl acetate ester, butyl acetate ester, fatty acid glycerin ester, etc.), and nitriles (for example, acetonitrile, etc.). These solvents may be used either singly or in combination of two or more species.

Emulsifiable concentrates of the antifouling compositions according to the present invention can also be obtained upon dilution of the combination of components (I) and (II) with at least a suitable organic solvent (i.e. a liquid carrier) followed by the addition of at least a solvent-soluble emulsifying agent. Solvents suitable for this type of formulation are usually water-immiscible and belong to the hydrocarbon, chlorinated hydrocarbon, ketone, ester, alcohol and amide classes of solvents, and they can be properly selected by those skilled in the art based on the solubility's of components (I) and (II) respectively. Emulsifiable concentrates usually contain, in addition to the organic solvent(s), from about 10 to 50% by weight of the combination of active ingredients, from about 2 to 20% of emulsifying agent(s) and up to 20% other additives such as stabilisers, corrosion inhibitors and the like. The combination of components (I) and (II) may also be formulated as a suspension concentrate, which is a stable suspension of the active ingredients in a (preferably organic) liquid intended to be diluted with water before use. In order to obtain such a non-sedimenting flowable product, it is usually necessary to incorporate therein up to about 10% by weight of at least a suspending agent selected from known protective colloids and thixotropic agents. Other liquid formulations like aqueous dispersions and emulsions, for example obtained by diluting a wettable powder or a concentrate (such as previously described) with water, and which may be of the water-in-oil or the oil-in-water type, also lie within the scope of the present invention.

The present invention also provides protective antifouling compositions, for instance in the form of paints, coatings or varnishes, comprising the said combination of components (I) and (II) together with one or more additives suitable for their formulation. The total amount of the combination of components (I) and (II) in such protective compositions may range from 2 to 10% (w/v). Suitable additives for use in said protective compositions are quite conventional in the art and include, for instance, at least an organic binder (preferably in aqueous form) such as an acrylic or vinyl-based emulsion or rosin compounds; mineral carriers such as calcium carbonate; surface-active agents such as previously described; viscosity regulators; corrosion inhibitors; pigments such as titanium dioxide; stabilisers such as sodium benzoate, sodium hexametaphosphate and sodium nitrite; mineral or organic colorants and the like. The ways of formulating such additives together with the component (I) and one or more components (II) of the present invention is also well within the knowledge of those skilled in the art. Such protective compositions may be used not only to cure and/or limit the damaging effects of fouling organisms but also in order to prevent deterioration to occur on materials which may be subjected to the harmful environment and effects of fouling organisms.

The antifouling compositions according to the present invention can be applied by a number of conventional methods, such as hydraulic spray, air-blast spray, aerial spray, atomising, dusting, scattering or pouring. The most appropriate method will be chosen by those skilled in the art in accordance with the intended objectives and the prevailing circumstances, namely the kind of fouling organism to be controlled, the type of equipment available and the type of material to be protected.

As previously indicated, the combination of components (I) and (II) is preferably applied in the form of compositions wherein both said ingredients are intimately admixed in order to ensure simultaneous administration to the materials to be protected. Administration or application of both components (I) and (II) can also be a “sequential-combined” administration or application, i.e. component (I) and component (II) are administered or applied alternatively or sequentially in the same place in such a way that they will necessarily become admixed together at the site to be treated. This will be achieved namely if sequential administration or application takes place within a short period of time e.g. within less than 24 hours, preferably less than 12 hours. This alternative method can be carried out for instance by using a suitable single package comprising at least one container filled with a formulation comprising the active component (I) and at least one container filled with a formulation comprising an active component (II). Therefore the present invention also encompasses a product containing:
(a) a composition comprising 4-bromo-2-(4-chloro-phenyl)-5-(trifluoromethyl)-1H-pyrrole-3-carbonitrile, or a salt thereof, as component (I), and
(b) a composition comprising a component (II), selected from 4-bromo-2-(4-chlorophenyl)-5-(trifluoromethyl)-1H-pyrrole-3-carbonitrile, or a salt thereof, together with one or more biocidal compounds selected from (4-isopropyl-pyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol and its derivatives, N,N-bis(3-aminopropyl)dodecylamine, coco(fractionated)benzyldimethylammonium chloride, peracetic acid, pyridaben, tebufenpyrad, and zosteric acid, as a combination for simultaneous or sequential use, wherein said (a) and (b) are in respective proportions to provide a synergistic effect against fouling organisms.

### EXPERIMENT

### Poison Plate Assay

### Experiment 1

### Poison Plate Assay

| Name of the | 4-bromo-2-(4-chloro-phenyl)-5-(trifluoromethyl)- |
|---|---|
| primary | 1H-pyrrole-3-carbonitrile as component (I) |
| compound: | |
| Name of the | (4-isopropylpyridinio)methyldiphenylboron as |
| combination | component (II-a); |
| partners: | triphenylboron pyridine as component (II-b); |
| | benzalkonium chloride as component (II-c); |
| | capsaicine as component (II-d); |
| | clonidine as component (II-e); |
| | fenazaquin as component (II-f); |
| | glutaric dialdehyde as component (II-g); |
| | menadione sodium bisulfite as component (II-h); |
| | menadione piperazine bisulfite as component (II-i); |
| | menadione triaminetriazine bisulfite as |
| | component (II-j); |
| | menthol as component (II-k); |
| | N,N-bis(3-aminopropyl)-dodecylamine as |
| | component (II-l); |
| | coco(fractionated)benzyldimethylammonium |
| | chloride as component (II-m); |
| | peracetic acid as component (II-n) |
| | pyridaben as component (II-o); |
| | tebufenpyrad as component (II-p); |
| | zosteric acid as component (II-r). |
| Stock solution: | 8000 and 80.000 ppm in DMSO |
| Test | % product A + % product B |
| combinations: | 100 + 0 |
| | 80 + 20 |
| | 66 + 33 |
| | 50 + 50 |
| | 33 + 66 |
| | 20 + 80 |
| | 0 + 100 |

Concentrations used for fenazaquin, and glutaric dialdehyde—concentrations of total single active ingredient in the toxicity tests—a series of concentrations increasing with steps of 1/3: 0.03-0.04-0.05-0.06-0.08-0.11-0.15-0.20-0.27-0.35-0.47-0.63-0.84-1.13-1.50-2.00-2.67-3.56-4.75-6.33-8.44-11.25-15.00-20.00-26.70-35.60-47.46-63.28-84.38-112.50-150.00-200.00 ppm.

Concentrations used for fenazaquin, and glutaric dialdehyde—concentrations of total active ingredient in the combination tests: a series of concentrations increasing with steps of 1/3: 0.08-0.11-0.15-0.20-0.27-0.35-0.47-0.63-0.84-1.13-1.50-2.00-2.67-3.56-4.75-6.33-8.44-11.25-15.00-20.00 ppm. Concentrations used for (4-isopropylpyridinio)methyldiphenylboron, triphenylboron pyridine, benzalkonium chloride, menadione sodium bisulfite, N,N-bis(3-aminopropyl)dodecylamine, peracetic acid, pyridaben, and tebufenpyrad—concentrations of total single active ingredient in the toxicity tests: a series of concentrations increasing with steps of 1/3: 0.27-0.35-0.47-0.63-0.84-1.13-1.50-2.00-2.67-3.56-4.75-6.33-8.44-11.25-15.00-20.00-26.70-35.60-47.46-63.28-84.38-112.50-150.00-200.00 ppm.

Concentrations used for (4-isopropylpyridinio)methyldiphenylboron, triphenylboron pyridine, benzalkonium chloride, menadione sodium bisulfite, N,N-bis(3-aminopropyl)dodecylamine, peracetic acid, pyridaben, and tebufenpyrad—concentrations of total active ingredient in the combination tests: a series of concentrations increasing with steps of 1/3: 0.03-0.05-0.06-0.08-0.11-0.14-0.19-0.25-0.34-0.45-0.60-0.80-1.07-1.42-1.90-2.53-3.38-4.50-6.00-8.00 ppm.

| Culture medium: | algae: BG 11 liquid mineral medium | |
|---|---|---|
| | Artemia salina: artificial seawater | |
| Experimental set up: | 24-well plates | |
| Species of algae: | (1): Chlorella vulgaris | CCAP 211/12 |
| | (2): Anabaena cylindrica | CCAP 1403/2A |
| | (3): Chlamydomonas sphagnophila | CCAP 11/36E |

| | |
|---|---|
| Inoculum: | algae: 1990 μl of a 1/10 dilution in BG 11 of a |
| | two week old culture |
| | Artemia: 1990 μl artificial seawater with 20-40 |
| | Artemia larvae (24 hours old) |
| Culture conditions: | 21° C., 65% relative humidity, 1000 lux, 16 hour |
| | photoperiod |
| Evaluation: | algae: after 3 weeks of exposure |
| | Artemia: after 24 hours of exposure |

Synergism between component (I) and one of the components (II) was determined by a commonly used and accepted method described by Kull F. C. et al. in Applied Microbiology, 9, 538-541 (1961) using the Synergy Index, which is calculated as follows for two compounds A and B:

$$Synergy Index ( SI ) = \frac{{Q}_{a}}{{Q}_{A}} + \frac{{Q}_{b}}{{Q}_{B}}$$

wherein:
Q_{A} is the concentration of compound A in ppm, acting alone, which produced an end point (e.g. MIC),
Qₐ is the concentration of compound A in ppm, in the mixture, which produced an end point (e.g. MIC),
Q_{B} is the concentration of compound B in ppm, acting alone, which produced an end point (e.g. MIC),
Q_{b} is the concentration of compound B in ppm, in the mixture, which produced an end point (e.g. MIC).

MIC is the minimum inhibitory concentration, i.e. the lowest concentration of each test compound or mixture of test compounds sufficient to inhibit visible growth.

When the Synergy Index is greater than 1.0, antagonism is indicated. When the SI is equal to 1.0, additivity is indicated. When the SI is less than 1.0, synergism is demonstrated.

When the Synergy Index is greater than 1.0, antagonism is indicated. When the SI is equal to 1.0, additivity is indicated. When the SI is less than 1.0, synergism is demonstrated.

TABLE 1
MIC-values (minimum inhibitory concentration in ppm)
and synergy index of various active ingredients and
their combination against Artemia salina

| | | MIC-values in | synergy |
|---|---|---|---|
| Combination | ratio (I) to (II) | ppm | index |
| (I) + (II-c) | 100 + 0 | 0.08 | — |
| (I) + (II-c) | 80 + 20 | 0.08 | 0.80 |
| (I) + (II-c) | 66 + 33 | 0.11 | 0.92 |
| (I) + (II-c) | 50 + 50 | 0.14 | 0.88 |
| (I) + (II-c) | 33 + 66 | 0.19 | 0.80 |
| (I) + (II-c) | 20 + 80 | 0.34 | 0.88 |
| (I) + (II-c) | 0 + 100 | 10.66 | — |
| (I) + (II-h) | 100 + 0 | 0.14 | — |
| (I) + (II-h) | 80 + 20 | 0.11 | 0.63 |
| (I) + (II-h) | 66 + 33 | 0.19 | 0.91 |
| (I) + (II-h) | 50 + 50 | 0.19 | 0.68 |
| (I) + (II-h) | 33 + 66 | 0.25 | 0.60 |
| (I) + (II-h) | 20 + 80 | 0.45 | 0.66 |
| (I) + (II-h) | 0 + 100 | 26.67 | — |
| (I) + (II-n) | 100 + 0 | 0.08 | — |
| (I) + (II-n) | 80 + 20 | 0.06 | 0.60 |
| (I) + (II-n) | 66 + 33 | 0.11 | 0.92 |
| (I) + (II-n) | 50 + 50 | 0.14 | 0.88 |
| (I) + (II-n) | 33 + 66 | 0.19 | 0.80 |
| (I) + (II-n) | 20 + 80 | 0.34 | 0.88 |
| (I) + (II-n) | 0 + 100 | 10.66 | — |

TABLE 2
MIC-values (minimum inhibitory concentration in
ppm) and synergy index of various active ingredients
and their combination against algae

| | algae | | MIC-values | synergy |
|---|---|---|---|---|
| Combination | species | ratio (I) to (II) | in ppm | index |
| (I) + (II-a) | (1) | 100 + 0 | 10.66 | — |
| (I) + (II-a) | (1) | 80 + 20 | 6.00 | 0.53 |
| (I) + (II-a) | (1) | 66 + 33 | 4.50 | 0.47 |
| (I) + (II-a) | (1) | 50 + 50 | 3.38 | 0.39 |
| (I) + (II-a) | (1) | 33 + 66 | 4.50 | 0.38 |
| (I) + (II-a) | (1) | 20 + 80 | 4.50 | 0.45 |
| (I) + (II-a) | (1) | 0 + 100 | 4.50 | — |
| (I) + (II-c) | (2) | 100 + 0 | 10.66 | — |
| (I) + (II-c) | (2) | 80 + 20 | 6.00 | 0.72 |
| (I) + (II-c) | (2) | 66 + 33 | 3.38 | 0.46 |
| (I) + (II-c) | (2) | 50 + 50 | 3.38 | 0.53 |
| (I) + (II-c) | (2) | 33 + 66 | 3.38 | 0.61 |
| (I) + (II-c) | (2) | 20 + 80 | 3.38 | 0.66 |
| (I) + (II-c) | (2) | 0 + 100 | 4.50 | — |
| (I) + (II-f) | (1) | 100 + 0 | 26.7 | — |
| (I) + (II-f) | (1) | 80 + 20 | 15.0 | 0.56 |
| (I) + (II-f) | (1) | 66 + 33 | 15.0 | 0.56 |
| (I) + (II-f) | (1) | 50 + 50 | 15.0 | 0.56 |
| (I) + (II-f) | (1) | 33 + 66 | 20.0 | 0.75 |
| (I) + (II-f) | (1) | 20 + 80 | 26.7 | 1.00 |
| (I) + (II-f) | (1) | 0 + 100 | 26.7 | — |
| (I) + (II-g) | (3) | 100 + 0 | 0.27 | — |
| (I) + (II-g) | (3) | 80 + 20 | 0.27 | 0.81 |
| (I) + (II-g) | (3) | 66 + 33 | 0.36 | 0.90 |
| (I) + (II-g) | (3) | 50 + 50 | 0.47 | 0.90 |
| (I) + (II-g) | (3) | 33 + 66 | 0.63 | 0.83 |
| (I) + (II-g) | (3) | 20 + 80 | 1.13 | 0.94 |
| (I) + (II-g) | (3) | 0 + 100 | 8.44 | — |
| (I) + (II-h) | (1) | 100 + 0 | 15.0 | — |
| (I) + (II-h) | (1) | 80 + 20 | 10.07 | 0.87 |
| (I) + (II-h) | (1) | 66 + 33 | 8.00 | 0.80 |
| (I) + (II-h) | (1) | 50 + 50 | 4.50 | 0.53 |
| (I) + (II-h) | (1) | 33 + 66 | 6.00 | 0.80 |
| (I) + (II-h) | (1) | 20 + 80 | 6.00 | 0.88 |
| (I) + (II-h) | (1) | 0 + 100 | 6.00 | — |
| (I) + (II-l) | (2) | 100 + 0 | 10.66 | — |
| (I) + (II-l) | (2) | 80 + 20 | 8.00 | 0.96 |
| (I) + (II-l) | (2) | 66 + 33 | 4.50 | 0.61 |
| (I) + (II-l) | (2) | 50 + 50 | 3.38 | 0.53 |
| (I) + (II-l) | (2) | 33 + 66 | 3.38 | 0.61 |
| (I) + (II-l) | (2) | 20 + 80 | 3.38 | 0.66 |
| (I) + (II-l) | (2) | 0 + 100 | 4.50 | — |
| (I) + (II-o) | (3) | 100 + 0 | 0.15 | — |
| (I) + (II-o) | (3) | 80 + 20 | 0.15 | 0.80 |
| (I) + (II-o) | (3) | 66 + 33 | 0.20 | 0.89 |
| (I) + (II-o) | (3) | 50 + 50 | 0.27 | 0.91 |
| (I) + (II-o) | (3) | 33 + 66 | 0.36 | 0.81 |
| (I) + (II-o) | (3) | 20 + 80 | 0.63 | 0.86 |
| (I) + (II-o) | (3) | 0 + 100 | 26.67 | — |
| (I) + (II-p) | (1) | 100 + 0 | 26.67 | — |
| (I) + (II-p) | (1) | 80 + 20 | 11.25 | 0.43 |
| (I) + (II-p) | (1) | 66 + 33 | 11.25 | 0.43 |
| (I) + (II-p) | (1) | 50 + 50 | 11.25 | 0.43 |
| (I) + (II-p) | (1) | 33 + 66 | 15.00 | 0.58 |
| (I) + (II-p) | (1) | 20 + 80 | 15.00 | 0.58 |
| (I) + (II-p) | (1) | 0 + 100 | 26.67 | — |

Species of algae:
(1): Chlorella vulgaris
(2): Anabaena cylindrica
(3): Chlamydomonas sphagnophila

### Experiment 2

### Exposure in the Oosterschelde of PVC boards

Test model: exposure in the Oosterschelde of painted PVC boards
Name of the primary compound: 4-bromo-2-(4-chloro-phenyl)-5-(trifluoromethyl)-1H-pyrrole-3-carbonitrile as component (I)
Name of the combination partners: capsaicine as component (II-d);
   clonidine as component (II-e);
   zosteric acid as component (II-r).
Test formulations: Paint formulation comprising xylene (47.7%), light aromatic solvent naphtha (CAS 64742-95-6) (16.2%), propylene oxide (0.06%), and zinc oxid (2.24%). Paint was diluted with 10% xylene to obtain the wet paint which was applied to the panels.
Dosage: Individual test compounds were added at a concentration of 1.8% by weight in the wet paint, resulting in 2.78% by weight in the dry paint film.
Test specimens: PVC boards with dimensions of 10×2×0.5 cm. Individual test panels were weighed before exposure at the test site in order to allow assessment of fresh and dry weight of fouling organisms at final evaluation.
Surface treated: 6×5 cm, four sides of the test panel.
Application rate: 220 g/m² in 2 layers.
Conditioning after treatment: 2 weeks in the laboratory.
Locations: Oosterschelde, Bruinisse (N 51° 39′ 6.1″; E 4° 5′ 51.9″), The Netherlands.
Interpretation of results: fouling was evaluated primarily with observations at both front and back side of test panels (panels exposed in relative darkness).
Depth of exposure: below a floating raft.
Exposure period: 18 weeks.
Validation placebo panels showed fair (53%) coverage with animal fouling.
Evaluation: Three parameters were measured after 18 weeks in order to estimate fouling and for calculating synergy:
1. Percentage coverage of the panels by fouling organisms as estimated visually.
2. Fresh weight of fouling organisms on panels in gram.
3. Dry weight of fouling organisms on panels in gram. Synergy evaluation: Synergy was tested according to the method of Limpel (Limpel, L. E., Schuldt, P. H., and Lamont, D. Weed Control Conf. 16: 48-53, 1962) as described in Colby (Colby, S. R., Weeds 15: 20-22, 1967) and Richer (Richer, D. L., Pesticide Science 19: 309-315, 1987). The single active ingredients were applied at a concentration of 2.78% in the dried coating. In the combinations, both actives were applied at 2.78%, resulting in 5.54% of total active ingredient. When X=% of observed effect (fouling inhibition as compared to untreated control) of compound A single and Y=% of observed effect of compound B single, the expected efficacy of the combination would be Eₑ=X+Y−XY/100.
Synergy is assumed when the observed efficacy Eₒ>Eₑ or Eₒ>X+Y−XY/100.
Results: After 18 weeks of exposure, the control panels showed 66% coverage at the front side and 40% coverage at the back side by animal foulers.

TABLE 3
Efficacy against animal fouling of test compound
combinations exposed for 18 weeks.

| Compo- | Coverage | | | Fresh weight | | | Dry weight | | |
|---|---|---|---|---|---|---|---|---|---|
| nent | C_{O} | % Eₒ | % Eₑ | Fw | % Eₒ | % Eₑ | D_{w} | % Eₒ | % Eₑ |
| Control | 53.0 | — | — | 4.60 | — | — | 3.12 | — | — |
| (I) | 42.5 | 19.8 | — | 2.90 | 36.0 | — | 1.94 | 37.9 | — |
| (II-d) | 65.0 | −22.6 | — | 5.50 | −21.3 | — | 3.58 | −14.6 | — |
| (II-e) | 72.5 | −36.8 | — | 6.10 | −33.8 | — | 3.92 | −25.6 | — |
| (II-r) | 57.5 | −8.5 | — | 5.40 | −18.4 | — | 2.05 | 34.5 | — |
| (I) + | 19.0 | 64.2 | 1.70 | 1.80 | 61.2 | 22.3 | 0.97 | 68.8 | 28.8 |
| (II-d) | | | | | | | | | |
| (I) + | 2.50 | 95.3 | −9.7 | 0.50 | 89.5 | 14.3 | 0.34 | 89.2 | 22.0 |
| (II-e) | | | | | | | | | |
| (I) + | 30.5 | 42.5 | 13.0 | 2.20 | 51.3 | 24.2 | 1.41 | 54.9 | 59.3 |
| (II-r) | | | | | | | | | |

Values are means (% coverage) or totals (weights) of front and backsides of panels. Synergies in bold.
Legend:
Cₒ = percentage coverage,
Eₒ = observed efficay,
Eₑ = expected efficay,
F_{w} = fresh weight in gram,
D_{w} = dry weight in gram.

1. A composition comprising a combination of 4-bromo-2-(4-chlorophenyl)-5-(trifluoromethyl)-1H-pyrrole-3-carbonitrile, or a salt thereof, as a component (I) together with one or more biocidal compounds as a component (II) selected from (4-isopropylpyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol or a derivative thereof, N,N-bis(3-aminopropyl)dodecylamine, coco(fractionated)benzyl-dimethylammonium chloride, peracetic acid, pyridaben, tebufenpyrad, and zosteric acid;
whereby component (I) and one of the components (II) are in respective proportions to provide a synergistic effect against fouling organisms.

2. A composition as claimed in claim 1 wherein the component (II) is (4-isopropyl-pyridinio)methyldiphenylboron or triphenylboron pyridine.

3. A composition as claimed in claim 1 wherein the component (II) is benzalkonium chloride.

4. A composition as claimed in claim 1 wherein the component (II) is capsaicine.

5. A composition as claimed in claim 1 wherein the component (II) is clonidine.

6. A composition as claimed in claim 1 wherein the component (II) is fenazaquin, pyridaben or tebufenpyrad.

7. A composition as claimed in claim 1 wherein the component (II) is glutaric dialdehyde or peracetic acid.

8. A composition as claimed in claim 1 wherein the component (II) is menadione sodium bisulfite, menadione piperazine bisulfite or menadione triaminetriazine bisulfite.

9. A composition as claimed in claim 1 wherein the component (II) is menthol or a derivative thereof.

10. A composition as claimed in claim 1 wherein the component (II) is N,N-bis(3-aminopropyl)dodecylamine or coco(fractionated)benzyldimethylammonium chloride.

11. A composition as claimed in claim 1 wherein the component (II) is zosteric acid.

12. A composition according to claim 1 wherein the ratio by weight of component (I) to one of the components (II) is 10:1 to 1:10.

13. A composition according to claim 1 wherein the ratio by weight of component (I) to one of the components (II) is 3:1 to 1:3.

14. A composition as claimed in claim 1 wherein the amount of component (I) ranges from 1 wt % to 40 wt % based on the total weight of the composition.

15. (canceled)

16. A method of protecting materials against fouling organisms, wherein the said method comprises administration or application of an antifouling effective amount of a composition according to claim 1.

17. A method of disinfecting ballast water by adding an antifouling effective amount of a composition according to claim 1.

18. A product containing
(a) a composition comprising 4-bromo-2-(4-chloro-phenyl)-5-(trifluoromethyl)-1H-pyrrole-3-carbonitrile, or a salt thereof, as component (I), and
(b) a composition comprising a component (II), selected from 4-bromo-2-(4-chlorophenyl)-5-(trifluoromethyl)-1H-pyrrole-3-carbonitrile, or a salt thereof, together with one or more biocidal compounds selected from (4-isopropylpyridinio)methyldiphenylboron, triphenylboron pyridine, benzalkonium chloride, capsaicine, clonidine, fenazaquin, glutaric dialdehyde, menadione sodium bisulfite, menadione piperazine bisulfite, menadione triaminetriazine bisulfite, menthol and its derivatives, N,N-bis(3-aminopropyl)-dodecylamine, coco(fractionated)benzyldimethylammonium chloride, peracetic acid, pyridaben, tebufenpyrad, and zosteric acid,
as a combination for simultaneous or sequential use, wherein said (a) and (b) are in respective proportions to provide a synergistic effect against fouling organisms.

19. A method of controlling fouling organisms on an object comprising applying on said object an antifouling amount of a composition according to claim 1.
